(19) United States
(12) Patent Application Publication
(10) Pub. No.: US 2014/0239752 A1
(43) Pub. Date: Aug. 28, 2014

(54) Stepper Motor Rotor with Internal Damper

(71) Applicant: KOLLMORGEN CORPORATION, Radford, VA (US)

(72) Inventor: Bradley A. TRAGO, Blacksburg, VA (US)

(73) Assignee: KOLLMORGEN CORPORATION, Radford, VA (US)

(21) Appl. No.: 13/775,716

(22) Filed: Feb. 25, 2013

(51) Int. Cl. H02K 5/24; H02K 15/03; H02K 15/02

(52) U.S. Cl. CPC H02K 5/24; H02K 15/02; H02K 15/03
USPC 310/51; 29/598

(57) ABSTRACT

A rotor for an electric motor with improved oscillation settling characteristics has a shaft rotatable about a longitudinal axis, a rotor section, disposed on the shaft for rotation together with the shaft, and, in certain arrangements, a permanent magnet disposed adjacent to the rotor section for rotation together with the shaft. The rotor section defines a recess around the shaft, extending from an end of the rotor section axially toward the opposite end of the rotor section, or the permanent magnet, if it is provided, and at least one mass is secured to the rotor section within the recess by a layer of deformable damping material, such as a dielectric gel. The rotor is particularly appropriate for use in a hybrid stepper motor, a variable reluctance motor, or a permanent magnet brushless motor, and a process of assembling the rotor is also referred to.

### BACKGROUND OF THE INVENTION

1. Field of the Invention

This invention concerns certain rotor constructions for stepper motors that help reduce undesired oscillations during settling periods.

2. Description of Related Art

Modern stepper motor arrangements typically use high energy rare earth magnets in their rotor constructions. FIG. 1 is a side view of a known rotor structure of a rare earth hybrid stepper motor assembly having one typical construction. In the assembly shown here, rotor sections 10, 12, commonly formed from a series of stacked laminations that are bonded together, are keyed or otherwise secured to a rotor shaft 14 for rotation together with the rotor shaft. A rare earth magnet 20 is sandwiched between respective facing adjacent ends 16, 18 of the rotor sections 10, 12. The rotor sections 10, 12 may be solid and annular, with the rotor shaft 14 extending through aligned central openings in the magnet 20 and the rotor sections 10, 12.

Some known designs have “cup” or “reverse cup” constructions. One design with a reverse cup construction is illustrated in FIG. 2, which shows cup-shaped rotor sections 10a, 12a, again commonly formed from a series of laminations, that are keyed or otherwise secured to a rotor shaft 14a. Each of the rotor sections 10a, 12a shown has a respective annular recess 22, 24 formed therein to reduce inertia and facilitate response characteristics. Typically, a design such as that shown in FIG. 2 will have an inertia that is about 30% lower than that of the design shown in FIG. 1. As with the arrangement shown in FIG. 1, the rotor shaft 14a extends through aligned central openings in the rotor sections 10a, 12a, and a rare earth magnet 20a is sandwiched between respective facing adjacent ends 16a, 18a of the rotor sections 10a, 12a.

In the rotor having the reverse cup construction illustrated in FIG. 2, ends of the annular recesses 22, 24 open axially outward. It will be recognized, however, that rotor sections in a cup construction such as that shown in FIG. 3 have oppositely oriented annular recesses, with ends that open axially inward. These open ends can at least partially receive the rare earth magnet as illustrated. More particularly, in the construction shown in FIG. 3, cup-shaped rotor sections 10b, 12b, again commonly formed from a series of laminations, are keyed or otherwise secured to a rotor shaft 14b. Each of the rotor sections 10b, 12b shown has a respective annular recess 22, 24 formed therein to hold a magnet 20b, which is typically an alnico magnet. The rotor shaft 14b extends through aligned central openings in the rotor sections 10b, 12b, and the magnet 20b, typically alnico, is received within the recesses 22 and 24 in the rotor sections 10b, 12b. The alnico magnet 20b used in the cup construction shown in FIG. 3 is significantly thicker (commonly seven times thicker) than the rare earth magnets used in the constructions represented in FIGS. 1 and 2. Other magnet types, such as ferrite magnets, can be used in this arrangement.

In some motors using rotors with cup constructions or reverse cup constructions, the cups are solid rather than laminated. While these solid cups have superior damping characteristics, losses associated with these constructions are significant, rendering these particular rotor constructions useful for applications generally under 150 rpm.

Problems associated with stepper motor “ring out” and smoothness issues have long been recognized. Among known ways of addressing these problems are mechanically damping out undesired oscillations with external dampers and electronic damping of undesired oscillations.

U.S. Pat. No. 4,623,812 to van de Griend discloses a concrete example of an electric motor including a rotor body, provided with a cylindrical magnet, that is elastically mounted on a rotor shaft in such a way that torsional vibrations are dampened or absorbed. The disclosure of the van de Griend ('812) patent is incorporated herein by reference in its entirety as non-essential subject matter. Other techniques include the use of ferrofluids, although these tend to be unreliable, as the fluid exhibits desired damping, but characteristics of the fluid change with temperature fluctuations. Another problem concerns migration of fluid from the air gap over time, reducing the desired behavior over time.

The use of an external damper, such as a fluid filled or “clean” damper, is illustrated by way of FIG. 4, which provides an outside view of one external damper arrangement. In the arrangement shown in FIG. 4, an external damper housing 30 is disposed at one end of a stator housing 32. A hub 34, securable to a rotor shaft (not shown) protruding from the housing 32, typically has vanes or other structures mounted thereon for movement through viscoelastic fluid or other material enclosed in the damper housing 30. External dampers utilizing viscoelastic or elastic material and movable masses of this sort are widely used, but these external dampers take up additional space outside the motor and its housing.

### SUMMARY OF THE INVENTION

One object of the invention is to provide a low cost, “no footprint” way of providing effective reduction of settling time for a system such as a stepper motor system. An arrangement according to the invention allows for smoother motor operation at low speeds, and effectively reduces the ring out time for a single step response. In one preferred arrangement, a rotor for an electric motor with improved oscillation settling characteristics has a shaft rotatable about a longitudinal axis, a rotor section, disposed on the shaft for rotation together with the shaft, and, optionally, a permanent magnet disposed adjacent to the rotor section for rotation together with the shaft. The rotor section defines a recess around the shaft, extending from an end of the rotor section axially toward the opposite end, or, if it is provided, the permanent magnet. At least one mass is secured to the rotor section within the recess by a layer of deformable damping material, such as a dielectric gel.

The mass can be annular, and is preferably secured by the layer of deformable damping material to an inwardly facing circumferential wall of the rotor section defining the recess. The rotor section referred to, moreover, can be the first of two rotor sections. When used in conjunction with a permanent magnet, the second rotor section is disposed on the shaft at a side of the permanent magnet opposite the first rotor section. In this arrangement, another mass is preferably secured within a recess in the second rotor section by another layer of deformable damping material.

In each case, the layer of deformable damping material is preferably disposed between an outer circumferential surface of the mass and an inner circumferential surface of the rotor section surrounding the recess. If desired, the layer may be disposed only between the outer circumferential surface of the mass and the inner circumferential surface of the rotor section. The rotor of the present invention is particularly suitable for use in a hybrid stepper motor, although it is also possible to utilize the rotor and attendant techniques on brushless motors, variable reluctance motors, and motors of other types.

The invention also concerns a stepper motor including a rotor such as that mentioned, as well as a process of assembling the rotor.

### BRIEF DESCRIPTION OF THE DRAWINGS

FIG. 1, discussed above, is a side view of a known rotor assembly for a rare earth hybrid stepper motor.

FIG. 2, discussed above, is view similar to FIG. 1 of another known rotor assembly.

FIG. 3, discussed above, is a view similar to FIG. 1 of yet another known rotor assembly.

FIG. 4, discussed above, is a view from outside a known stepper motor arrangement having an external rotor oscillation damper.

FIG. 5 is a sectional view through one embodiment of a rotor according to the present invention.

FIG. 6 is a sectional view similar to FIG. 5 but of another embodiment of the rotor.

FIG. 7 is a view, in perspective, of part of the rotor shown in FIG. 5, and showing a lamination side surface.

FIG. 8 is a sectional view similar to FIG. 6 but through an embodiment of a rotor according to the present invention without a magnet.

FIG. 9 is a sectional view of another rotor embodiment without a magnet according to the invention.

FIG. 10 illustrates performance characteristics for different rotor assemblies.

FIG. 11 shows a portion of the performance characteristics included in FIG. 10 using an expanded time scale.

FIG. 12 illustrates the relatively insignificant effects on motor torque characteristics produced when using the present invention.

### DETAILED DESCRIPTION OF THE INVENTION

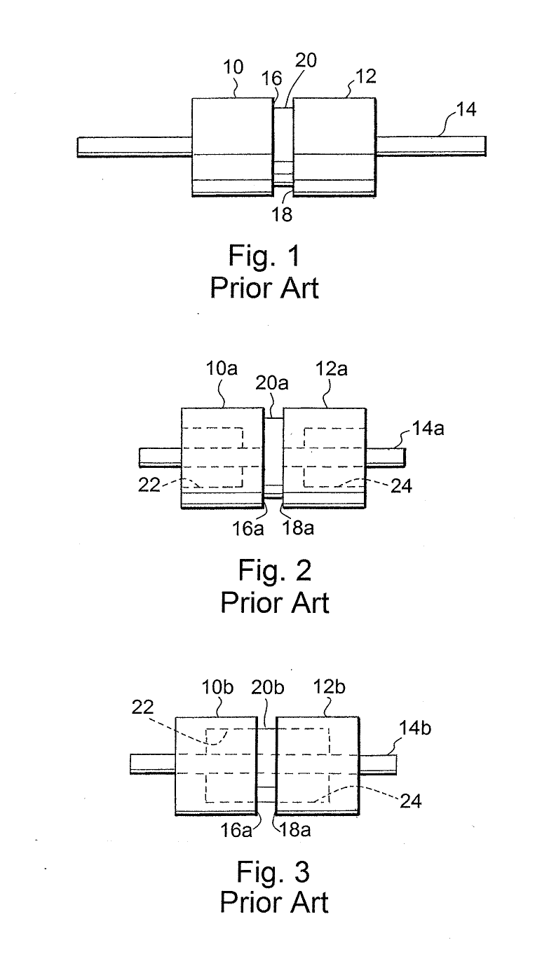

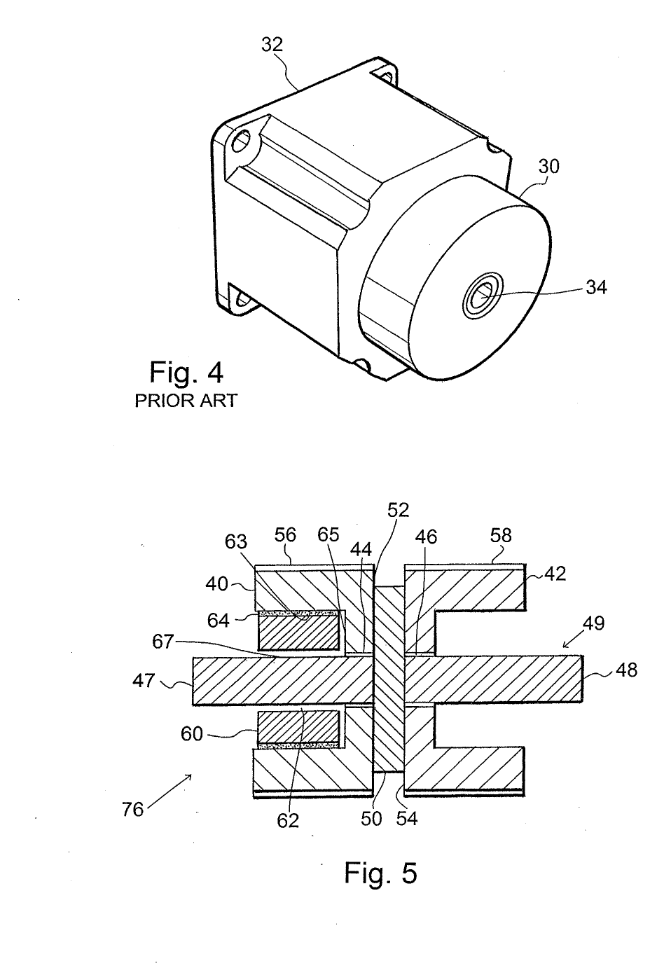

FIG. 5 is a sectional view through one embodiment of a rotor according to the present invention. Here, rotor sections 40, 42 may be formed from a series of laminations rigidly secured to each other by way of interlocks (portions 57 of which are shown in FIG. 7) or in some other conventional manner. The rotor sections may be connected, by interlocking teeth 44, 46 as shown, by slot and key connections, by press fitting, or in some other suitable fashion to respective portions 47, 48 of a rotor shaft 49. As in the conventional reverse cup construction shown in FIG. 2, a typically rare earth permanent magnet 50 is sandwiched between adjacent ends 52, 54 of the rotor sections 40, 42 so as to be connected to the rotor shaft 49 for rotation about a longitudinal axis along with the rotor sections 40, 42. The rotor shaft 49, of course, could be more conventionally configured as a single, solid rotor shaft extending through aligned central openings in the rotor section 40, the magnet 50, and the rotor section 42 instead of separate rotor shaft portions 46, 48 divided by the magnet 50 as shown in FIG. 5. Teeth 56, 58 are distributed around respective outer circumferential surfaces of the rotor sections 40, 42 in the usual manner for torque producing purposes.

FIG. 5 also shows an annular slug or mass 60 of iron, steel, lead, or other suitable material as suspended by way of a damping material layer 64 of a viscous, elastically or plastically deformable substance within an annular recess 62 formed in the rotor section 40. During operation of a stepper motor incorporating the rotor illustrated, the layer 64 acts as a damper to settle, i.e. dampen out or dissipate, oscillations produced. As illustrated, the layer 64 secures the mass 60 to an inwardly facing, circumferentially extending side surface 63 of the rotor section 40, although the mass 60 could alternatively or additionally be secured by that layer 64 to an end surface 65 of the recess 62, to an exterior surface 67 of the rotor shaft portion 46, or both. The deformable substance mentioned is preferably a toughened dielectric gel having the properties of DOW CORNING 3-4207 “Tough Gel” or DOW CORNING 3-4222 “Firm Gel,” for example.

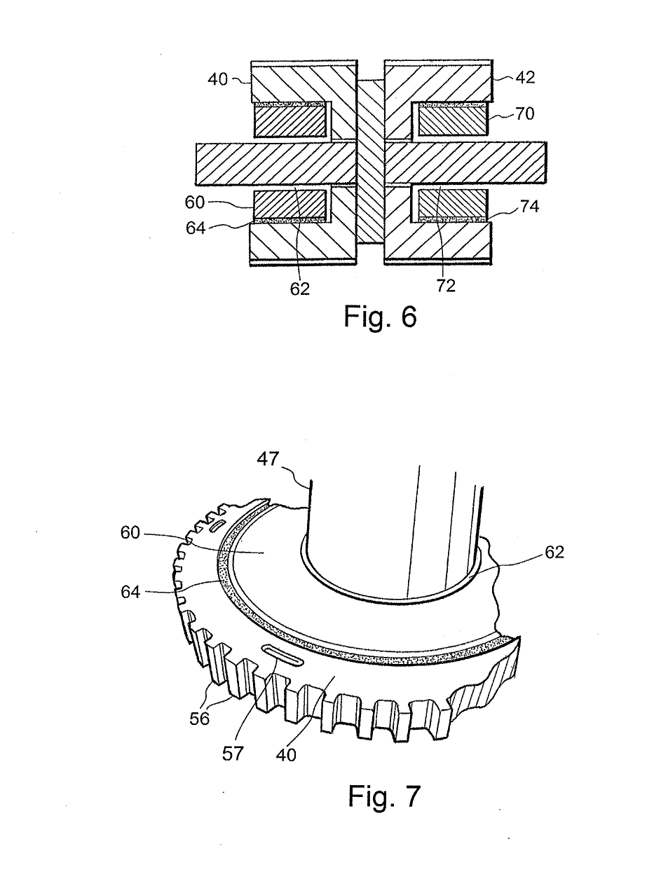

FIG. 6 illustrates another embodiment of the invention, in which each rotor section includes an annular mass in a recess defined therein. In the embodiment shown in FIG. 6, the annular slug or mass 60 of iron, steel, lead, or other suitable material is suspended by way of the damping material layer 64 within the annular recess 62 formed in the rotor section 40, and another annular slug or mass 70, also of iron, steel, lead, or other suitable material, is suspended by way of a damping material layer 74 within an annular recess 72 formed in the rotor section 42. Each mass 60, 70 could alternatively or additionally be secured by the respective layers 64, 74 to other surfaces delimiting the recesses 62, 72 in the same way as the mass 60 of the arrangement shown in FIG. 5.

FIG. 7 is an enlarged view of a side surface of an end lamination, forming part surface of the rotor section 40 shown in FIG. 5, as seen in a direction 76. Visible in FIG. 7 are the rotor shaft portion 47, the annular slug or mass 60, the annular recess 62, the layer 64 of the deformable substance, and the teeth 56 distributed around the circumferential surface of the rotor section 40. Multiple individual masses of lead, iron, or other suitable material, appropriately balanced and distributed, could be used in place of the single annular mass 60, shown in FIGS. 5 and 7, or in place of either mass or both masses 60, 70, shown in FIG. 6, if desired.

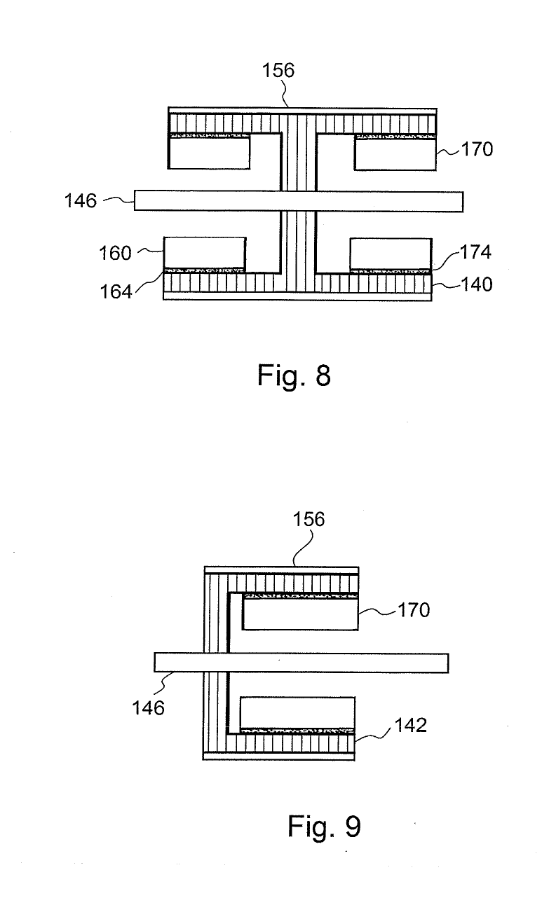

FIGS. 8 and 9 are sectional views through other rotor embodiments according to the present invention that are appropriate for use in variable reluctance motors or stepper motors without magnets. A construction very similar to those of FIGS. 8 and 9 could be used for surface magnet brushless motors according to the invention. Referring initially to FIG. 9, a single rotor section 142, which, again, may be formed from a series of laminations that are interconnected in a conventional manner, is connected in a suitable fashion to a rotor shaft 146. As before, teeth 156 are distributed around the outer circumferential surface of the rotor section 142 in the usual manner.

FIG. 9 also shows an annular slug or mass 170 of iron, steel, lead, or other suitable material as suspended by way of a damping material layer of the viscous, elastically or plastically deformable substance mentioned, which is disposed within an annular recess formed in the rotor section 142. As with the embodiments described above, during operation of a motor incorporating the rotor illustrated, the layer mentioned acts as a damper to settle oscillations produced. It is once again to be noted that, while the layer shown in FIG. 9 secures the mass 170 to an inwardly facing, circumferentially extending side surface of the rotor section, that mass could alternatively or additionally be secured by the layer to an end surface of the recess, to an exterior surface of the rotor shaft 146, or both.

FIG. 8, of course, illustrates an embodiment in which a rotor section 140 includes two annular recesses, each having an annular mass therein. The rotor section 140, again, is mounted on a rotor shaft 146, and has teeth 156 distributed about its outer circumference. In the embodiment shown in FIG. 8, the annular slug or mass 160 of iron, steel, lead, or other suitable material is suspended by way of the damping material layer 164 within one annular recess formed in the rotor section 140, and another annular slug or mass 170, also of iron, steel, lead, or other suitable material, is suspended by way of a damping material layer 174 within another annular recess formed in the rotor section 140. Each mass 160, 170 could alternatively or additionally be secured by the respective layers 164, 174 to other surfaces delimiting the recesses in the same way as the mass 60 of the arrangement shown in FIG. 5.

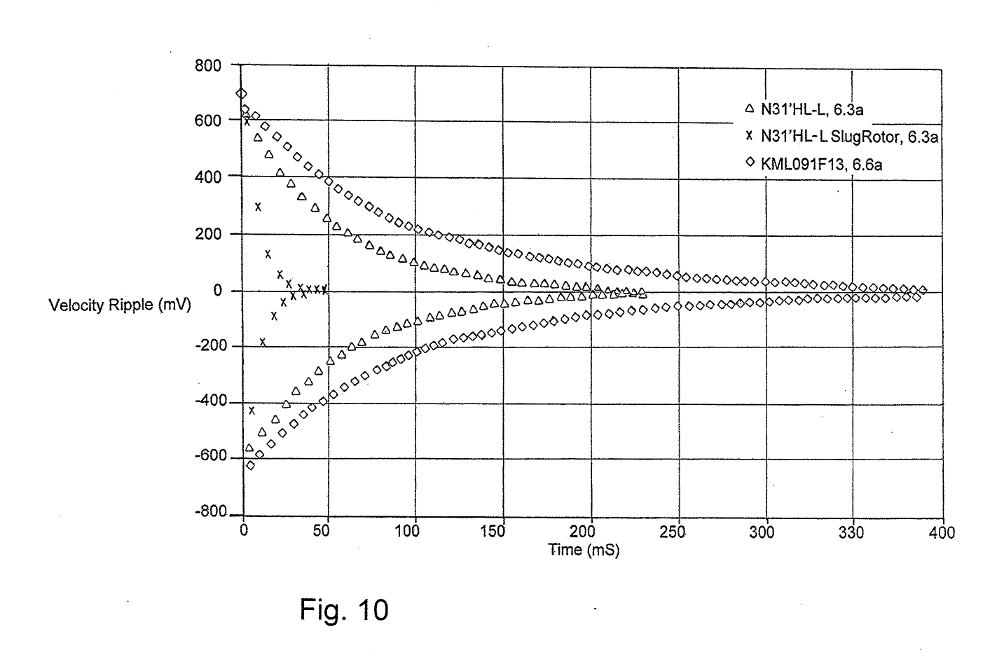

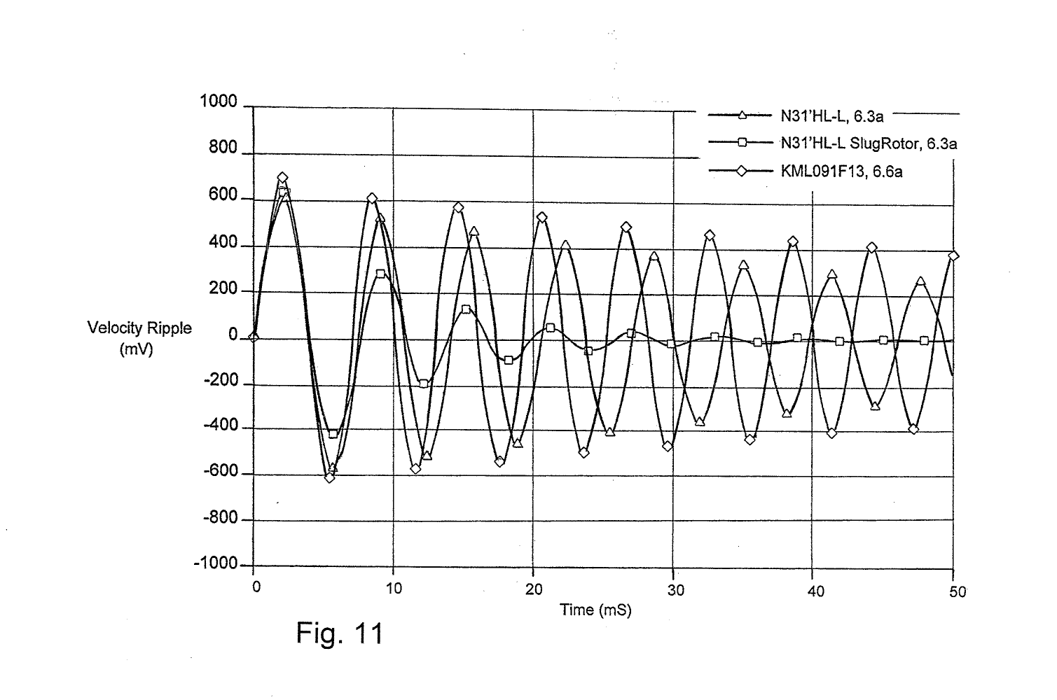

FIG. 10 illustrates the performance of three different rotor assemblies subjected to respective impulses, and exhibits respective damped responses in shaft movement, produced by plotting peaks and valleys of the rotor velocity measured by a shaft-mounted tachometer, as a function of time, in mS. Each point illustrated in FIG. 10 identifies a turning point, representing the local maximum or minimum, in shaft movement. The plot identified by the legend “N31′HL-L, 6.3a” illustrates velocity ripple as a function of time for a known arrangement such as that shown in FIG. 2, the plot identified by the legend “N31′HL-L, SlugRotor 6.3a” illustrates the same relationship for an arrangement according to the invention such as that shown in FIG. 5, and the plot identified by the legend KML091F13, 6.6a” illustrates the same relationship for another known arrangement such as that shown in FIG. 2. FIG. 11 shows the same respective damped responses in shaft movement as FIG. 10, but with an expanded or enlarged time scale and including plots of the oscillation signals overall rather than just their turning points.

Although the inertia increase with the arrangement shown in FIG. 5 relative to the arrangement shown in FIG. 2 is on the order of 11%, the arrangement shown in FIG. 5 is still considered advantageous; the effect on damping and single step response provided by the arrangement shown in FIG. 5 appears quite pronounced, with shaft oscillation substantially eliminated after about 25 mS.

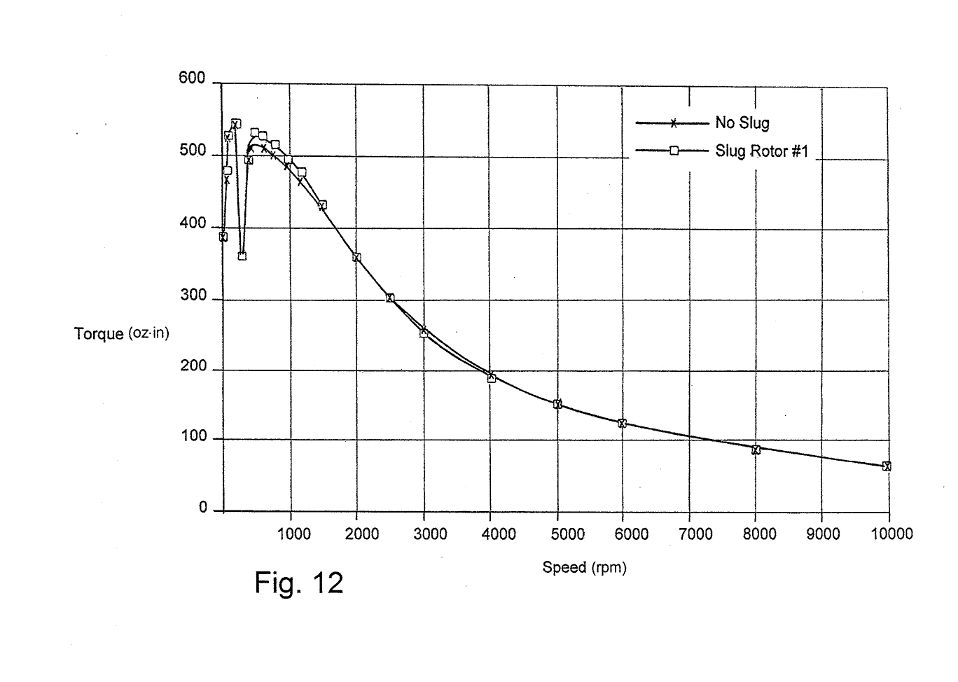

FIG. 12 shows plots of torque (oz·in) as a function of speed (rpm) for arrangements such as those shown in FIG. 2 (No Slug) and FIG. 5 (Slug Rotor #1), and illustrates that motor torque characteristics are not significantly affected by addition of the slug or mass 60.

It is contemplated that a mass, such as the mass 60, or a plurality of masses could be added to existing rotors having structures similar to that illustrated in FIG. 2 to improve operational characteristics in the manner described. An arrangement in accordance with the present invention could provide a number of advantages, since a conventional external damper adds space, is expensive, is visible from outside the motor, raises safety issues, requires a double shaft, and makes mounting an encoder difficult. A conventional internal damper, on the other hand, also requires added space, and may add unacceptable cost, especially with housingless motors, since expensive laminated steel enclosures are required. Spinning safety is not an issue, as with motors having external dampers, and interference with external encoder mountings is not a problem. Using a rotor-mounted internal damper such as that described requires no additional housing space, produces no safety issues, does not interfere with encoder mounting, can be implemented readily without an increase in lamination cost or an enlarged housing, and uses existing hollow lamination structure for mounting. The present invention also does not suffer from windup characteristics, which can arise in the arrangement forming the subject matter of the van de Griend (812) patent mentioned above.

The foregoing disclosure has been set forth merely to illustrate the invention and is not intended to be limiting. Modifications of the disclosed embodiments incorporating the spirit and substance of the invention may occur to persons skilled in the art, and the invention should be construed to include everything within the scope of the invention ultimately claimed.

1. A rotor for an electric motor having improved oscillation settling characteristics, the rotor comprising:
a shaft rotatable about a longitudinal axis,
a rotor section, disposed on the shaft for rotation together with the shaft, the rotor section defining a recess around the shaft extending from an end of the rotor section axially toward an opposite end of the rotor section, and
at least one mass secured to the rotor section within the recess by a layer of deformable damping material.

2. The rotor of claim 1, wherein the at least one mass is annular.

3. The rotor of claim 2, wherein the mass is secured by the layer of deformable damping material to an inwardly facing circumferential wall of the rotor section defining the recess.

4. The rotor of claim 1, wherein the rotor section is a first rotor section, and further comprising a second rotor section disposed on the shaft at a side of the rotor opposite the first rotor section.

5. The rotor of claim 4, further comprising another mass secured within a recess in the second rotor section by another layer of deformable damping material.

6. The rotor of claim 1, wherein the layer of deformable damping material is disposed between an outer circumferential surface of the mass and an inner circumferential surface of the rotor section surrounding the recess.

7. The rotor of claim 6, wherein the layer is disposed only between the outer circumferential surface of the mass and the inner circumferential surface of the rotor section.

8. The rotor of claim 1, wherein the motor is any of a hybrid stepper motor, a variable reluctance motor, and a permanent magnet brushless motor.

9. The rotor of claim 1, wherein the deformable damping material is a dielectric gel.

10. The rotor of claim 1, further comprising a permanent magnet disposed adjacent to the rotor section for rotation together with the shaft, wherein the recess extends from the end of the rotor section axially toward the permanent magnet.

11. A stepper motor including a rotor having improved oscillation settling characteristics, the rotor comprising:
a shaft rotatable about a longitudinal axis,
a rotor section, disposed on the shaft for rotation together with the shaft, the rotor section defining a recess around the shaft extending from an end of the rotor section axially toward an opposite end of the rotor section, and
at least one mass secured to the rotor section within the recess by a layer of deformable damping material.

12. The stepper motor of claim 11, wherein the at least one mass is annular.

13. The stepper motor of claim 12, wherein the mass is secured by the layer of deformable damping material to an inwardly facing circumferential wall of the rotor section defining the recess.

14. The stepper motor of claim 11, wherein the rotor section is a first rotor section, and further comprising a second rotor section disposed on the shaft at a side of the rotor opposite the first rotor section.

15. The stepper motor of claim 14, further comprising another mass secured within a recess in the second rotor section by another layer of deformable damping material.

16. The stepper motor of claim 11, wherein the layer of deformable damping material is disposed between an outer circumferential surface of the mass and an inner circumferential surface of the rotor section surrounding the recess.

17. The stepper motor of claim 16, wherein the layer is disposed only between the outer circumferential surface of the mass and the inner circumferential surface of the rotor section.

18. The stepper motor of claim 11, wherein the deformable damping material is a dielectric gel.

19. The stepper motor of claim 11, further comprising a permanent magnet disposed adjacent to the rotor section for rotation together with the shaft, wherein the recess extends from the end of the rotor section axially toward the permanent magnet.

20. A process of assembling a rotor for a motor having improved oscillation settling characteristics comprising:
providing a rotor section on a shaft for rotation together with the shaft such that the rotor section defines a recess around the shaft extending from an end of the rotor section axially toward an opposite end of the rotor section, and
securing at least one mass to the rotor section within the recess by a layer of deformable damping material.

21. The process of claim 20, wherein the at least one mass is annular.

22. The process of claim 20, wherein the deformable damping material is a dielectric gel.

23. The process of claim 20, wherein a permanent magnet is provided adjacent to the rotor section, and the recess extends from the end of the rotor section axially toward the permanent magnet.
